(19) United States
(12) Patent Application Publication
(10) Pub. No.: US 2024/0195655 A1
(43) Pub. Date: Jun. 13, 2024

(54) MOBILITY SERVICE SUPPORT METHOD AND MOBILITY SERVICE SUPPORT SYSTEM

(71) Applicants: HYUNDAI MOTOR COMPANY, Seoul (KR); KIA CORPORATION, Seoul (KR)

(72) Inventors: HeeJin RO, Seoul (KR); Donghee SEOK, Seoul (KR); Sanghyun HWANG, Seoul (KR); Duckyoung KIM, Seongnam-si (KR); Jongbok LEE, Yongin-si (KR); Yocheol JANG, Suwon-si (KR)

(73) Assignees: Hyundai Motor Company, Seoul (KR); KIA CORPORATION, Seoul (KR)

(21) Appl. No.: 18/381,393

(22) Filed: Oct. 18, 2023

(30) Foreign Application Priority Data
Dec. 13, 2022 (KR) 10-2022-0173818

(51) Int. Cl. H04L 12/40

(52) U.S. Cl. CPC H04L 12/40006; H04L 2012/40215; H04L 2012/40273

(57) ABSTRACT

A method of supporting mobility service according to an embodiment of the disclosure includes receiving, by a mobility data development platform, a request for providing information on a mobility device from a mobility service provider, abstracting, by the mobility data development platform, information on the mobility device in response to receiving the request for providing information, and providing, by the mobility data development platform, the abstracted information on the mobility device to the mobility device.

### CROSS-REFERENCE TO RELATED APPLICATION(S)

This application claims the benefit of Korean Patent Application No. 10-2022-0173818, filed on Dec. 13, 2022 in the Korean Intellectual Property Office, the entire contents of which application are incorporated herein by reference.

### TECHNICAL FIELD

The present disclosure relates to a mobility service, and more particularly to providing data to support a mobility service business.

### BACKGROUND

Generally, mobility services are expanding and moving towards open platforms. In such a situation, the demand for driving data or status data of mobility devices needed to provide mobility services is increasing, but the development of open platforms is currently slow.

Edge Intelligence (EI) refers to analyzing data and developing solution together at a site where the data is generated. EI may be realized through application development at a connected terminal level of mobility devices, but in terms of a security or safety, it is not possible to disclose all of driving data or health data of the mobility devices. In particular, in the case of driving data of a mobility device, sufficient attention is required in granting read/write permissions. Herein, read may be a concept of obtaining data, and write may be a concept of performing control via a controller area network (CAN) communication.

A conventional connected mobility device technology only allows a mobility device owner to control under limited conditions, such as starting the mobility device or locking/unlocking a door through a dedicated application.

Recently, some of a mobility device's data may be shared through a dedicated application programming interface (API) of a mobility service cloud to provide connected services of the mobility device. However, even in this case, it may be shared (or provided) only through a defined API. For example, among mobility device data, only data related to insurance, etc. is shared (or provided) for analysis, and control, such as starting the mobility device or locking/unlocking a door is not allowed to mobility service providers (MSPs).

The disadvantages that may result from the above are as follows:

The mobility service cloud can only analyze data, and in a connected terminal level of mobility device it is difficult to develop and apply service functions, such as logistics/sharing through the development of EI functions.

In addition, as CAN specifications (e.g., CAN database files) for each type/year of mobility device are different, even if the data is the same, it is not easy to read (i.e., acquire data) and write (i.e., perform control) the data.

In addition, as firmware development is independently performed according to the type/year of the mobility device, it is difficult to develop firmware to respond to different types/years of the mobility device.

In addition, as status data for each type/year of mobility device is different, it is difficult to ensure data consistency.

In addition, it takes a lot of time to verify the sending/receiving of data, even after the development for the implementation of mobility services is underway.

In addition, current mobility service providers are not allowed to receive all CAN data from mobility devices due to security regulations of mobility device manufacturers, and only allow very limited standardized information (e.g., OBD-II standard) to be used for mobility services. In addition to the standardized information, other necessary data may be obtained through reverse engineering. However, data obtained through reverse engineering is difficult to fully trust. In addition, reverse engineering is costly and time-consuming.

In addition, if the mobility device is needed to be controlled (e.g., lock/unlock a door or start an engine), which may be done by modifying a smart key (e.g., fob), but this may raise other issues such as security or stability.

### SUMMARY

An aspect of the present disclosure provides, in a situation where mobility services continue to expand and change to an open platform, an open platform development environment for the development of EI algorithms at a connected terminal level of the mobility device. To this end, by abstracting and providing mobility device data related to security or safety through cloud-to-platform interworking, it is possible to respond to the open platform development environment, thereby enabling the extension of mobility services.

Additional aspects of the present disclosure are set forth in part in the description which follows and, in part, should be understood from the description, or may be learned by practice of the disclosure.

In accordance with an aspect of the present disclosure, a method of supporting mobility service is provided. The method includes receiving, by a mobility data development platform, a request for providing information on a mobility device from a mobility service provider, abstracting, by the mobility data development platform, information on the mobility device in response to receiving the request for providing information, and providing, by the mobility data development platform, the abstracted information on the mobility device to the mobility device.

The information on the mobility device may include a controller area network (CAN) message of the mobility device.

The method may further include dividing the information on the mobility device into data for which provision of the CAN message of the mobility device is available and data for which provision of the CAN message of the mobility device is not available, and abstracting the data for which the provision of the CAN message of the mobility device is available and providing the abstracted data to the mobility device.

The abstracting of the information on the mobility device may be performed based on filtering information for the abstracting of the information on the mobility device.

The method may further include generating a library to be ported directly to the mobility device from the information on the mobility device through the abstraction based on the filtering information.

The request for providing information on the mobility device may be transmitted from the mobility service provider to the mobility data development platform through a developer dashboard.

The developer dashboard may include a consistency checking module configured to perform a consistency check of the library.

The information related to the mobility device may include driving data or state data of the mobility device.

In accordance with another aspect of the present disclosure, a system for supporting mobility service is provided. The system includes a developer dashboard configured to receive a request for providing information on a mobility device from a mobility service provider, and a mobility data development platform, communicably connected to the developer dashboard, configured to abstract information on the mobility device in response to receiving the request for providing information, and provide the abstracted information on the mobility device to the mobility device.

The information on the mobility device may include a CAN message of the mobility device.

The mobility data development platform may further divide into data for which provision of the CAN message of the mobility device is available and data for which provision of the CAN message of the mobility device is not available among the information on the mobility device, and abstract the data for which the provision of the CAN message of the mobility device is available and provide the abstracted data to the mobility device.

The abstraction of the information on the mobility device may be performed based on filtering information for the abstraction of the information on the mobility device.

The mobility data development platform may further generate a library to be ported directly to the mobility device from the information on the mobility device through the abstraction based on the filtering information.

The request for providing information on the mobility device may be transmitted from the mobility service provider to the mobility data development platform through the developer dashboard.

The developer dashboard may further include a consistency checking module configured to perform a consistency check of the library.

The information related to the mobility device may include driving data or state data of the mobility device.

In accordance with an aspect of the present disclosure, a method of supporting mobility service is provided. The method includes receiving, by a mobility data development platform, a request for providing information including a CAN message for a mobility device from a mobility service provider; abstracting, by the mobility data development platform, information on the mobility device in response to receiving the request for providing information, dividing the information on the mobility device into data for which provision of the CAN message is available and data for which provision of the CAN message is not available, and abstracting the data for which the provision of the CAN message is available; and providing, by the mobility data development platform, the abstracted information on the mobility device to the mobility device.

### BRIEF DESCRIPTION OF THE DRAWINGS

These and/or other aspects of the disclosure should be apparent and more readily appreciated from the following description of the embodiments, taken in conjunction with the accompanying drawings, in which:

FIG. 1 is a view illustrating an open platform development system for mobility services according to an exemplary embodiment of the present disclosure;

FIG. 2 is a view sequentially illustrating a data flow of the open platform development system for the mobility service shown in FIG. 1;

FIG. 3 is a view illustrating a method of developing an open platform for supporting mobility services according to an exemplary embodiment of the present disclosure;

FIG. 4 is a view illustrating a method of checking data consistency of a data consistency checking module; and

FIG. 5 is a view illustrating operations of a mobility development management module of a developer dashboard.

### DETAILED DESCRIPTION

Reference is made below in detail to the embodiments of the disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the disclosure are described in detail with reference to the accompanying drawings.

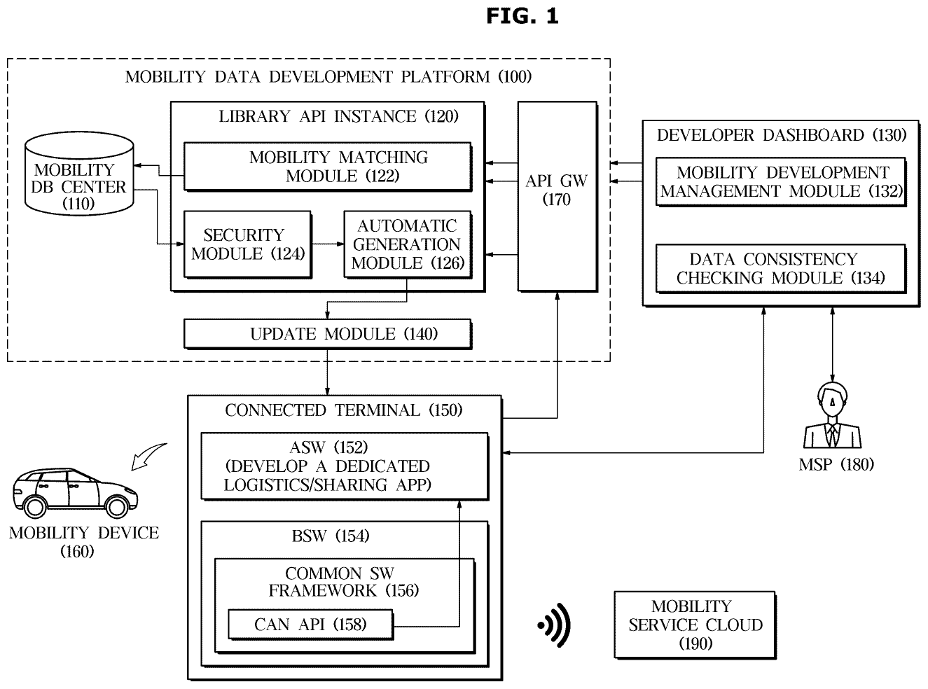

FIG. 1 is a view illustrating an open platform development system for mobility services according to an exemplary embodiment of the present disclosure. The open platform development system for mobility services shown in FIG. 1 is designed to develop mobility services in a connected form, and to abstract and provide mobility device data. ‘Connected’ refers to a state in which terminals or devices are connected to each other over a network to exchange information. In a connected form of mobility services, mobility devices are connected to each other over a network to exchange information.

As shown in FIG. 1, the open platform development system for mobility services according to an exemplary embodiment of the present disclosure includes a mobility data development platform 100, a developer dashboard 130, a connected terminal 150, a mobility service cloud 190, and a mobility service provider 180, which are connected to communicate with each other. The connected terminal 150 is a terminal installed in a mobility device 160. The mobility device 160 includes, but is not limited to, a vehicle and an electric vehicle.

The mobility data development platform 100 may include an application programming interface (API) gateway 170, a mobility database center 110, a library application programming interface (hereinafter, referred to as a library API) instance 120, and an update module 140. The mobility data development platform 100 can be implemented as one or more processors (e.g., computer, microprocessor, CPU, ASIC, circuitry, logic circuits, etc.) and an associated non-transitory memory storing software instructions which, when executed by the processor, provides the functionalities of the mobility data development platform 100 and its submodules (a mobility matching module 122, a security model 124, an automatic generation module 126, an update module 140, etc.,) as described here. Herein, the memory and the processor may be implemented as separate semiconductor circuits. Alternatively, the memory and the processor may be implemented as a single integrated semiconductor circuit. The processor may embody one or more processor(s).

The API gateway 170 may interworks with the mobility device 160 and the developer dashboard 130. The API gateway 170 allows driving/status information and development-related information of the mobility device 160 to be transferred between the mobility data development platform 100, the developer dashboard 130, and the mobility device 160.

The mobility database center 110 stores and manages mobility data for each mobility device 160. The mobility data includes raw CAN data related to the mobility device 160 and CAN DBC files. The CAN DBC files contain decoding information to represent the raw CAN data as actual physical values. The mobility database center 110 is only connected to an internal communication network of the mobility data development platform 100 in order to maintain the security of the data handling. In an embodiment of the present disclosure, when data processed by the mobility database center 110 is provided to the developer dashboard 130 or the like, the data is provided in an abstracted state and thus security is maintained. Abstraction of data refers to the conceptualization task that makes it easier to recognize by combining and simplifying the types of operations and representations associated with a single piece of data. In addition to CAN data according to CAN communication, data from different communication environments may be abstracted in the corresponding form of the communication environments (e.g., Ethernet).

The library API instance 120 includes a mobility matching module 122, a security module 124, and an automatic generation module 126.

The mobility matching module 122 requests the CAN DBC data related to the CAN data requested by the mobility service provider (also referred to as MSP) 180 to the mobility database center 110.

The security module 124 generates abstraction filtering information for abstracting CAN data based on a CAN message of the CAN DBC received from the mobility database center 110. The CAN message of the CAN DBC may include information, such as CAN ID, Start Bit, Data Length, and Mobility Speed. The security module 124 provides the generated abstraction filtering information to the automatic generation module 126.

The automatic generation module 126 automatically builds (or creates) a CAN API library (e.g., dynamic-link library (DLL)/shared object (SO), etc.) in a format that may be directly ported to the connected terminal 150 based on the abstraction filtering information received from the security module 124. The CAN API library is in binary machine language and does not contain any security information.

The update module 140 transmits the CAN API library automatically generated by the automatic generation module 126 to the connected terminal 150 when a CAN API request is generated by the connected terminal 150.

The developer dashboard 130 is a user interface provided to the mobility service provider 180. The mobility service provider 180 is classified according to a security level. The scope of use of the CAN data provided to the mobility service provider 180 is differentially managed (or restricted) according to the level (e.g., security level) of the mobility service provider 180. The lower the level of the mobility service provider 180 is, the more restricted the scope of the CAN data that the mobility service provider 180 can use. The developer dashboard 130 reviews and manages the selection of data to be provided to the mobility service provider 180 and a method of using the data according to information of the mobility device 160 registered by the mobility service provider 180. The information regarding the mobility device 160 registered by the mobility service provider 180 may include a vehicle identification number (VIN) of the corresponding mobility device 160. The developer dashboard 130 includes a mobility development management module 132 and a data consistency checking module 134. The developer dashboard 130 can be implemented as one or more processors (e.g., computer, microprocessor, CPU, ASIC, circuitry, logic circuits, etc.) and an associated non-transitory memory storing software instructions which, when executed by the processor, provides the functionalities of the developer dashboard 130 and its submodules (the mobility development management module 132, the data consistency checking module 134, etc.,) as described here. Herein, the memory and the processor may be implemented as separate semiconductor circuits. Alternatively, the memory and the processor may be implemented as a single integrated semiconductor circuit. The processor may embody one or more processor(s). The mobility development management module 132 and the data consistency checking module 134 may be stored in at least a memory of the developer dashboard 130 as software executed by the developer dashboard 130.

The mobility development management module 132 of the developer dashboard 130 performs the following tasks.
(a) User sign-up and approval
(b) User login
(c) User mobility registration/approval (administrator privilege)
(d) Assignment of a data access level for each user (read/write, etc.)
(e) Selection of mobility data
(f) Provision of specifications of mobility data (variable names for each mobility data and guidance on their use, etc.)

When the download of the mobility data library is completed by such tasks, the data consistency checking module 134 checks the data consistency of the updated mobility data library.

The data consistency checking module 134 performs the data consistency checking of the CAN API library downloaded from the connected terminal 150. To this end, the data consistency checking module 134 performs the following tasks.

The data consistency checking module 134 provides a user interface for providing real-time status for each mobility data.

The data consistency checking module 134 monitors the real-time status of the mobility device 160.

For example, the data consistency checking module 134 monitors (or verifies) a target that may grasp a current state of the mobility device 160 (e.g., whether a door is open or closed/RPM, etc.) through a real-time connection.

If it is difficult to monitor data through the real-time connection (e.g., sending/receiving data between ECUs), appropriate data may be monitored based on the consistency standard of the mobility service cloud 190.

In addition, the data consistency checking module 134 reports errors and issues related to data consistency found during the above-mentioned real-time connection monitoring (or verification) and consistency standard-based analysis, and corrects and applies the errors and issues.

The connected terminal 150 is provided in the mobility device 160. Application software (ASW) 152 and basic software (BSW) 154, which are used to operate the connected terminal 150, are embedded in the connected terminal 150.

The connected terminal 150 enables an open development environment to be provided by allowing mobility library files to be applied through the use of a common framework of the mobility device 160.

The connected terminal 150 provides driving/status data of the mobility device 160 from a CAN API 158 of a common software framework 156 to the ASW 152 based on information about the CAN DBC files for each vehicle type of the mobility device 160.

At this time, the CAN API 158 of the connected terminal 150 abstracts some data of the CAN messages of the mobility device 160 from the driving/state data of the mobility device 160, and then provides the abstracted some data of the CAN messages to the ASW 152. The abstracted message of the CAN messages of the mobility device 160 may be, for example, speed (e.g., mobility speed=60 km/h), provided in the form of a variable or function. The non-abstracted message of the CAN messages of the mobility device 160 may be, for example, security-related data, such as CAN ID, Start Bit, and Data Length (CAN ID: 0x111, Start Bit:5, Data Length: 8 bits . . . ).

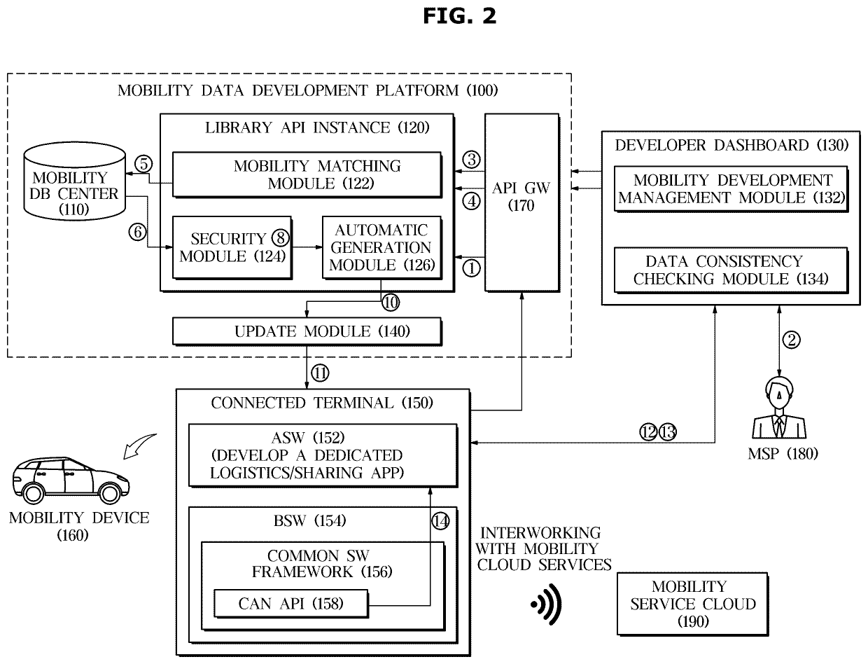

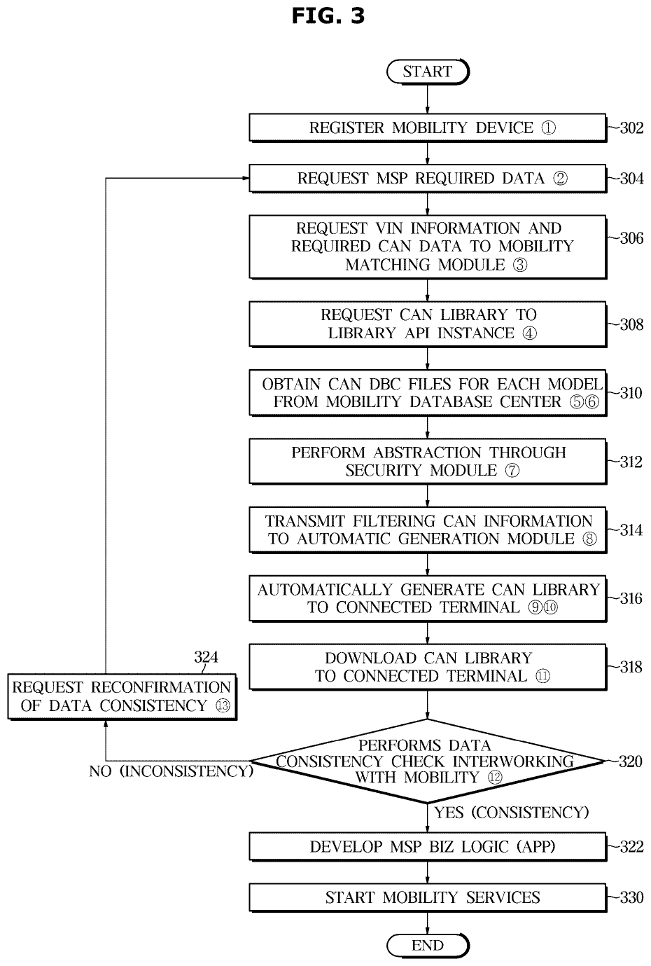

FIG. 2 is a view sequentially illustrating a data flow of an open platform development system for mobility services shown in FIG. 1. A method of developing an open platform for supporting mobility services according to an exemplary embodiment of the present disclosure will be described with reference to FIG. 3 to be described later along with FIG. 2.

FIG. 3 is a view illustrating a method of developing an open platform for supporting mobility services according to an exemplary embodiment of the present disclosure.

As shown in FIG. 3, the mobility service provider 180 registers the corresponding mobility device 160 via the API gateway 170 of the mobility data development platform 100 in the connected terminal 150 of the mobility device 160 to register for mobility services (operation 302) (see \textcircled{1} in FIG. 2).

The mobility service provider 180 requests the CAN data of the mobility device 160 required to provide mobility services to the mobility data development platform 100 via the developer dashboard 130 (operation 304) (see \textcircled{2} in FIG. 2).

The developer dashboard 130 requests vehicle information (e.g., VIN information) of the mobility device 160 and the required CAN data to the mobility matching module 122 of the mobility data development platform 100 in response to a request from the mobility service provider 180 (operation 306) (see \textcircled{3} in FIG. 2).

In addition, the developer dashboard 130 requests CAN library of the corresponding mobility device 160 to the library API instance 120 of the mobility data development platform 100 (operation 308) (see \textcircled{4} in FIG. 2).

The mobility matching module 122 of the mobility data development platform 100, in response to a request from the developer dashboard 130, requests CAN DBC data related to the CAN data requested by the mobility service provider 180 to the mobility database center 110 (see \textcircled{5} in FIG. 2).

According to this request, the CAN DBC files suitable for the model/year of the mobility device 160 is obtained from the mobility database center 110 (operation 310) (see \textcircled{6} in FIG. 2).

The security module 124 generates the abstraction filtering information for abstracting the CAN data based on the CAN messages of the CAN DBC received from the mobility database center 110 (operation 312). The CAN message may include information such as CAN ID, Start Bit, Data Length, and Mobility Speed, etc.) (see \textcircled{7} in FIG. 2>

The security module 124 provides the generated abstraction filtering information to the automatic generation module 126 (operation 314) (see \textcircled{8} in FIG. 2).

The automatic generation module 126 automatically generates the CAN API library (e.g., CAN API library, DLL/so, etc.) in a format that may be directly ported to the connected terminal 150 based on the abstraction filtering information received from the security module 124 (operation 316) (see \textcircled{9} and \textcircled{10} in FIG. 2). The CAN API library is in binary machine language and contains no security information.

The update module 140, in response to the CAN API request occurring from the connected terminal 150, transmits the CAN API library (e.g., CAN API library, DLL/so, etc.) automatically generated in the automatic generation module 126 to the connected terminal 150 (operation 318) (see \textcircled{11} in FIG. 2). As a result, the CAN API library of the connected terminal 150 may be updated.

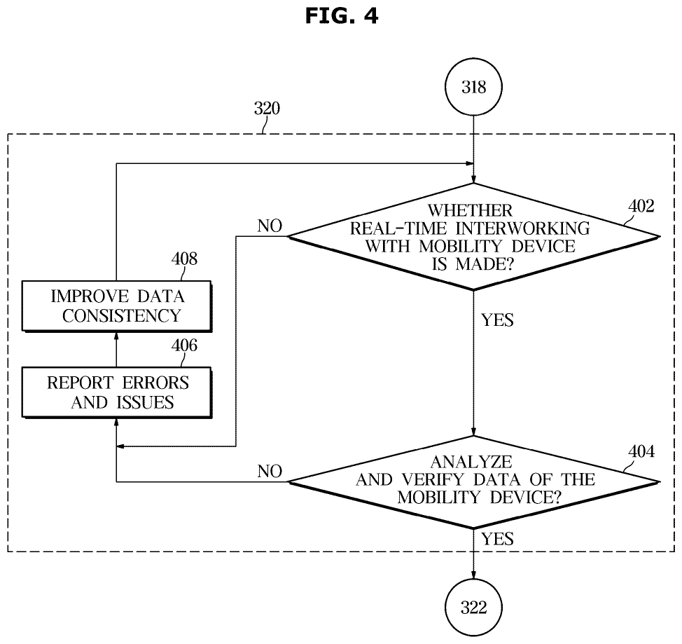

After the update of the CAN API library has been completed through the above operations, the data consistency checking module 134 performs the data consistency check of the updated CAN API library (operation 320) (see \textcircled{12} in FIG. 2). In addition, the data consistency checking module 134 reports errors and issues related to the data consistency found in the above-mentioned real-time interworking monitoring (or verification) and consistency standard-based analysis, and corrects and applies the errors and issues. This is described with reference to FIG. 4 as follows.

FIG. 4 is a view illustrating a data consistency check method of a data consistency checking module. For the data consistency check shown in FIG. 4, the data consistency checking module 134 provides a user interface for checking the data consistency of the CAN API library downloaded from the connected terminal 150, and a user interface for providing real-time status information for each mobility device 160.

The data consistency checking module 134 determines whether real-time interworking with the mobility device 160 has been made (operation 402).

If the real-time interworking with the mobility device 160 is made (Yes in operation 402), the data consistency checking module 134 monitors (analyzes and verifies) objects that may grasp the current state of the mobility device 160 (whether the door is open or closed/RPM, etc.) through the real-time connection (operation 404). If it is difficult to monitor data through the real-time connection (e.g., sending/receiving data between ECUs), the data consistency checking module 134 may be continuously analyzed and verified based on the consistency standard of the mobility service cloud 190.

If the real-time interworking with the mobility device 160 is not performed (No in operation 402), or if the monitoring (analysis and verification) through real-time interworking is not performed (No in operation 404), the consistency checking module 134 reports errors and issues related to data consistency found in the real-time interworking monitoring (analysis and verification) and consistency standard-based analysis (operation 406), and improves the errors and issues to resume the consistency check (operation 408).

Returning to FIG. 3, if the result of the data consistency check of the updated CAN API library is consistent (Yes (i.e., consistency) in operation 320), the connected terminal 150 applies the shared framework of the mobility device 160 and thus may apply mobility library files and provide an open development environment (operation 322).

If the result of the data consistency check of the updated CAN API library is inconsistent (No (i.e., inconsistency) in operation 320), the connected terminal 150 requests reconfirmation of the data consistency of the CAN API library to the data consistency checking module 134 of the developer dashboard 130 (operation 324) (see \textcircled{13} in FIG. 2).

At this time, the CAN API 158 of the connected terminal 150 abstracts some data of the CAN messages of the mobility device 160 from the driving/state data of the mobility device 160, and then provides the abstracted some data of the CAN messages to the ASW 152 (see \textcircled{14} in FIG. 2). The abstracted message of the CAN messages of the mobility device 160 may be, for example, speed (e.g., mobility speed=60 km/h), provided in the form of a variable or function. The non-abstracted message of the CAN messages of the mobility device 160 may be, for example, security-related data, such as CAN ID, Start Bit, and Data Length (CAN ID: 0x111, Start Bit: 5, Data Length: 8 bits . . . ).

After the development of the mobility service environment has been completed through such a series of operations, mobility services based on the completed mobility service environment may be started (operation 330).

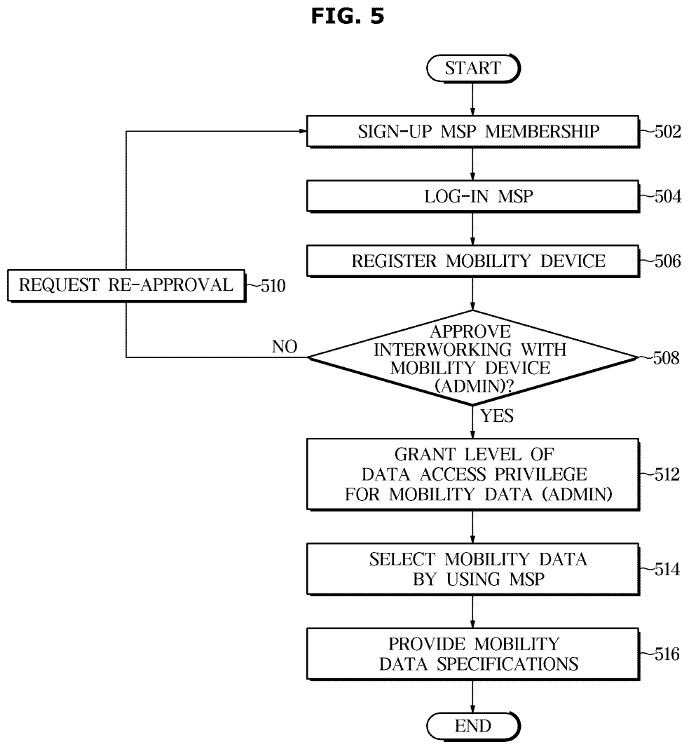

FIG. 5 is a view illustrating operations of the mobility development management module of the developer dashboard. The mobility development management module 132 of the developer dashboard 130 performs the following series of tasks.

The mobility development management module 132 performs the membership registration and approval of the mobility service provider 180 (operation 502). In other words, the mobility development management module 132 receives a membership request from the mobility service provider 180 wishing to sign-up as a member, evaluates membership qualifications according to predetermined criteria, and if the membership qualifications are satisfied, approves the membership of the corresponding mobility service provider 180.

The mobility service provider 180 whose membership registration is completed may enter the ID and password to log in to the mobility service (operation 504). The mobility development management module 132 confirms the ID and password input by the mobility service provider 180 and determines whether the mobility service provider 180 has normally completed the membership registration, and allows only for the mobility service provider 180 for which the membership registration has been completed normally to be log in.

After logging in, the mobility service provider 180 may register the mobility device 160 with the mobility services (operation 506). The mobility development management module 132 may perform procedures required to register the mobility device 160.

If the mobility device 160 satisfies all conditions required for registration and its registration is completed, the mobility development management module 132 approves the interworking between the mobility device 160 and the mobility development management module 132 (administrator privilege) (operation 508).

If the interworking between the mobility device 160 and the mobility development management module 132 is not approved (No in operation 508), approval may be attempted again through a re-authorization request (510).

If the interworking between the mobility device 160 and the mobility development management module 132 is approved (Yes in operation 508), the mobility development management module 132 grants the level of data access privilege for each mobility service provider 180 (differential application of read/write privileges) (operation 512).

The mobility service provider 180 may select (or request) the CAN data of the mobility device 160 that it requires (operation 514).

Specifications of the CAN data of the mobility device 160 required (or requested) by the mobility service provider 180 may be provided by the mobility database center 110 (operation 516). At this time, guidance on variable names for each CAN data of the mobility device and their uses may be given.

As apparently described above, various embodiments of the present disclosure may provide an open platform development environment for developing EI algorithms at the connected terminal level of the mobility device.

In addition, various embodiments of the present disclosure may enhance the mobility services by developing expanded mobility services, such as logistics/sharing and improving data utilization of mobility service providers.

In addition, various embodiments of the present disclosure may efficiently use data while maintaining data security by differentially applying data read (acquisition)/write (control) privileges based on the level of each mobility service provider.

On the other hand, the above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A method of supporting mobility service, the method comprising:
receiving, by a mobility data development platform, a request for providing information on a mobility device from a mobility service provider;
abstracting, by the mobility data development platform, information on the mobility device in response to receiving the request for providing information; and
providing, by the mobility data development platform, the abstracted information on the mobility device to the mobility device.

2. The method of claim 1, wherein the information on the mobility device includes a controller area network (CAN) message of the mobility device.

3. The method of claim 2, wherein further comprising:
dividing the information on the mobility device into data for which provision of the CAN message of the mobility device is available and data for which provision of the CAN message of the mobility device is not available; and
abstracting the data for which the provision of the CAN message of the mobility device is available and providing the abstracted data to the mobility device.

4. The method of claim 3, wherein the abstracting of the information on the mobility device is performed based on filtering information for the abstracting of the information on the mobility device.

5. The method of claim 4, further comprising: generating a library to be ported directly to the mobility device from the information on the mobility device through the abstraction based on the filtering information.

6. The method of claim 5, wherein the request for providing information on the mobility device is transmitted from the mobility service provider to the mobility data development platform through a developer dashboard.

7. The method of claim 6, wherein the developer dashboard includes a consistency checking module configured to perform a consistency check of the library,
wherein the consistency checking module stored in a memory of the developer dashboard.

8. The method of claim 1, wherein the information related to the mobility device includes driving data or state data of the mobility device.

9. A system for supporting mobility service, the system comprising:
a developer dashboard configured to receive a request for providing information on a mobility device from a mobility service provider; and
a mobility data development platform, communicably connected to the developer dashboard, configured to:
abstract information on the mobility device in response to receiving the request for providing information, and
provide the abstracted information on the mobility device to the mobility device.

10. The system of claim 9, wherein the information on the mobility device includes a controller area network (CAN) message of the mobility device.

11. The system of claim 10, wherein the mobility data development platform is further configured to:
divide the information on the mobility device into data for which provision of the CAN message of the mobility device is available and data for which provision of the CAN message of the mobility device is not available; and
abstract the data for which the provision of the CAN message of the mobility device is available and provide the abstracted data to the mobility device.

12. The system of claim 11, wherein the abstraction of the information on the mobility device is performed based on filtering information for the abstraction of the information on the mobility device.

13. The system of claim 12, wherein the mobility data development platform is further configured to generate a library to be ported directly to the mobility device from the information on the mobility device through the abstraction based on the filtering information.

14. The system of claim 13, wherein the request for providing information on the mobility device is transmitted from the mobility service provider to the mobility data development platform through the developer dashboard.

15. The system of claim 14, wherein the developer dashboard further includes a consistency checking module configured to perform a consistency check of the library,
wherein the consistency checking module stored in a memory of the developer dashboard.

16. The system of claim 9, wherein the information related to the mobility device includes driving data or state data of the mobility device.

17. A method of supporting mobility service, the method comprising:
receiving, by a mobility data development platform, a request for providing information including a controller area network (CAN) message for a mobility device from a mobility service provider;
abstracting, by the mobility data development platform, information on the mobility device in response to receiving the request for providing information, dividing into data for which provision of the CAN message is available and data for which provision of the CAN message is not available, and abstracting the data for which the provision of the CAN message is available; and
providing, by the mobility data development platform, the abstracted information on the mobility device to the mobility device.
